(19) United States
(12) Patent Application Publication
(10) Pub. No.: US 2026/0241678 A1
(43) Pub. Date: Aug. 20, 2026

(54) INKJET PRINTER

(71) Applicant: Roland DG Corporation, Hamamatsu-shi (JP)

(72) Inventors: Shinya YAMAMOTO, Hamamatsu-shi (JP); Takeshi YAGI, Hamamatsu-shi (JP); Keita YAMASAKI, Hamamatsu-shi (JP); Masaki YOSHIDA, Hamamatsu-shi (JP)

(21) Appl. No.: 19/642,849

(22) Filed: Apr. 9, 2026

Related U.S. Application Data
(63) Continuation of application No. PCT/JP2024/035614, filed on Oct. 4, 2024.

(30) Foreign Application Priority Data
Oct. 11, 2023 (JP) 2023-175806

(51) Int. Cl. B41J 2/045; B41J 2/14; B41J 11/00

(52) U.S. Cl. CPC B41J 2/04501; B41J 2/14; B41J 11/00218

(57) ABSTRACT

An inkjet printer includes a recording head including a first nozzle row and a second nozzle row, and a light irradiator including irradiation sections to individually adjust light amounts thereof, and a controller configured or programmed to include an acquisition section to acquire print data, a print pattern determination section to determine a print pattern indicating a combination of whether or not ink is ejected from the first nozzle row and whether or not ink is ejected from the second nozzle row, and an irradiation control section to adjust light amounts of the irradiation sections based on the print pattern.

### CROSS REFERENCE TO RELATED APPLICATIONS

This application claims the benefit of priority to Japanese Patent Application No. 2023-175806 filed on Oct. 11, 2023 and is a Continuation Application of PCT Application No. PCT/JP2024/035614 filed on Oct. 4, 2024. The entire contents of each application are hereby incorporated herein by reference.

### BACKGROUND OF THE INVENTION

### 1. Field of the Invention

The present invention relates to inkjet printers to print using a light-curable ink.

### 2. Description of the Related Art

Inkjet printers are known in the art that include a recording head to eject a light-curable ink onto a recording medium, a light irradiator for irradiating the light-curable ink on the recording medium with light, a scanning mechanism for moving the recording head and the light irradiator in the primary scanning direction, and a feed mechanism for moving the recording medium in the secondary scanning direction relative to the recording head and the light irradiator (e.g., JP 2019-123217 A). Note that the secondary scanning direction is a direction perpendicular to the primary scanning direction. With such inkjet printers, an image is formed on the recording medium by sequentially repeating the movement of the recording head and the light irradiator in the primary scanning direction and the relative movement of the recording medium in the secondary scanning direction.

Light emitted from the light irradiator may be reflected inside the printer to be incident on the nozzle surface of the recording head. If reflected light is incident on the nozzle surface of the recording head, ink in the nozzles may cure, potentially clogging the nozzles. Here, if the amount of light emitted from the light irradiator (hereinafter referred to as the light amount) is large, the reflected light increases, making nozzle clogging more likely to occur. On the other hand, if the light amount from the light irradiator is small, it is no longer possible to desirably cure the ink on the recording medium. Therefore, there is a demand for irradiating light from the light irradiator in an amount that is neither excessive nor insufficient.

JP 2019-123217 A describes a control where the light irradiator includes a plurality of light-emitting elements and, during printing, the light-emitting elements that are not facing the table are turned off. JP 2019-123217 A also describes a control where, among the plurality of light-emitting elements, those light-emitting elements that are facing the image data area (the area where ink is ejected) of the recording medium are turned on, while those light-emitting elements that are not facing the image data area are turned off. JP 2019-123217 A states that such control of turning light-emitting elements on/off suppresses the incidence of reflected light on the recording head.

### SUMMARY OF THE INVENTION

Example embodiments of the present invention provide inkjet printers each including a recording head to eject a light-curable ink, and a light irradiator, with which it is possible to improve print quality while reducing or preventing incidence of reflected light on the recording head.

An inkjet printer according to an example embodiment of the present invention includes a recording head including a first nozzle row including a plurality of nozzles arranged in a secondary scanning direction to eject a first light-curable ink toward a recording medium, a second nozzle row arranged on one side of the first nozzle row in a primary scanning direction perpendicular to the secondary scanning direction, the second nozzle row including a plurality of nozzles arranged in the secondary scanning direction to eject a second light-curable ink toward the recording medium. The inkjet printer includes a head scanner to move the recording head in the primary scanning direction, a feeder to move the recording head and the recording medium relative to each other in the secondary scanning direction, a light irradiator to irradiate light toward ink ejected from the recording head, and a controller configured or programmed to control the recording head, the head scanner, the feeder, and the light irradiator. The light irradiator includes a plurality of irradiation sections with positions that are different from each other in the secondary scanning direction, the irradiation sections being capable of individually adjusting light amounts thereof. The controller is configured or programmed to include an acquirer configured or programmed to acquire print data including data regarding an ejection action of the first nozzle row and the second nozzle row, a print pattern determinator configured or programmed to determine a print pattern indicating a combination of whether or not ink is ejected from the first nozzle row and whether or not ink is ejected from the second nozzle row based on the print data, and an irradiation controller configured or programmed to adjust the light amounts of the irradiation sections of the light irradiator based on the print pattern.

With the inkjet printer described above, the light irradiator includes a plurality of irradiation sections whose positions are different from each other in the secondary scanning direction, the irradiation sections being capable of individually adjusting light amounts thereof. Then, the light amounts of the irradiation sections are adjusted based on the print pattern indicating a combination of whether or not ink is ejected from the first nozzle row and whether or not ink is ejected from the second nozzle row. The light amounts of the irradiation sections can be adjusted in accordance with the whether or not ink is ejected from the first nozzle row and the second nozzle row. By adjusting the light amounts of the irradiation sections, it is possible to reduce or prevent excessive light irradiation from the light irradiator, and it is therefore possible to effectively reduce or prevent reflected light. Therefore, it is possible to reduce or prevent the incidence of reflected light on the recording head. By adjusting the light amounts of the irradiation sections, ink on the recording medium can be sufficiently irradiated with light, and it is therefore possible to improve the print quality.

According to example embodiments of the present invention, it is possible to provide inkjet printers each including a recording head to eject a light-curable ink, and a light irradiator, with which it is possible to improve print quality while reducing or preventing incidence of reflected light on the recording head.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of an inkjet printer according to an example embodiment of the present invention.

FIG. 2 is a front view of the inkjet printer with the cover open.

FIG. 3 is a plan view of a portion of the inkjet printer.

FIG. 4 is a diagram showing the arrangement of the recording head and the light irradiator.

FIG. 5 is a block diagram of the control system of the inkjet printer.

FIG. 6 is a diagram showing the presence/absence of ejection of each ink head and the light amount of each irradiation section for the first print pattern.

FIG. 7 is a diagram showing the presence/absence of ejection of each ink head and the light amount of each irradiation section for the second print pattern.

FIG. 8 is a diagram showing the presence/absence of ejection of each ink head and the light amount of each irradiation section for the third print pattern.

### DETAILED DESCRIPTION OF THE EXAMPLE EMBODIMENTS

Example embodiments of inkjet printers (hereinafter referred to as the printer or printers) according to the present invention will now be described with reference to the drawings.

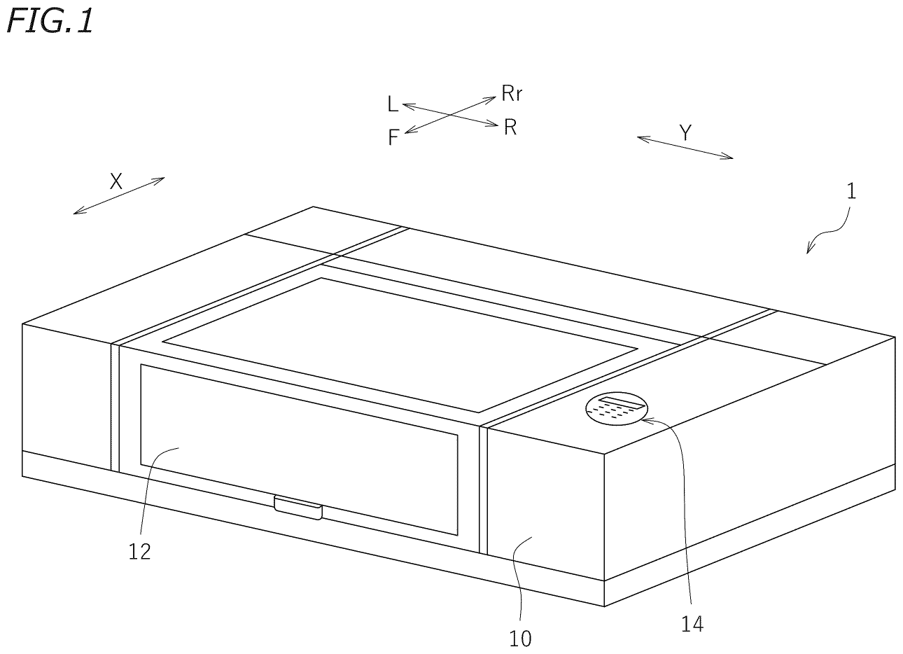

FIG. 1 is a perspective view of a printer 1 according to the present example embodiment. The designations F, Rr, L, and R in the figures refer to front, rear, left, and right, respectively. The designation Y represents the primary scanning direction, and the designation X represents the secondary scanning direction. Here, the primary scanning direction coincides with the left-right direction. The secondary scanning direction is a direction perpendicular to the primary scanning direction, and coincides with the front-rear direction here.

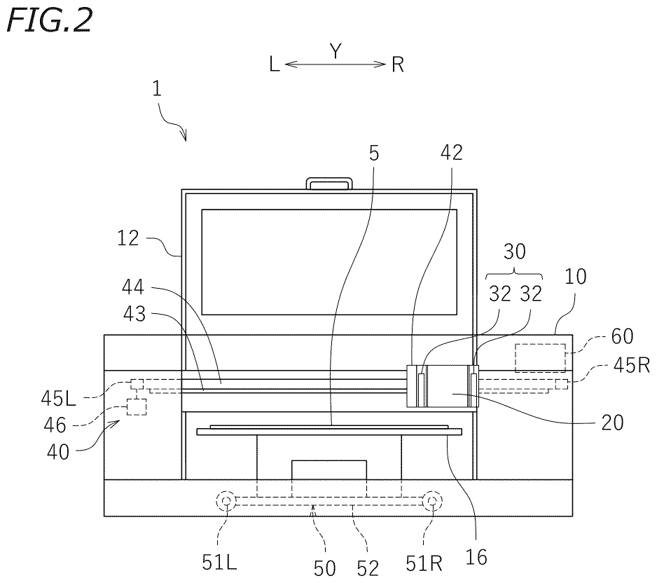

As shown in FIG. 1, the printer 1 includes a case 10, a front cover 12, and a control panel 14. Although not shown in the figures, a hinge is provided at the rear portion of the front cover 12. The front cover 12 is rotatably attached to the case 10 via the hinge. The front cover 12 can be opened/closed. FIG. 2 is a front view of the printer 1 with the front cover 12 open.

As shown in FIG. 2, the printer 1 includes a table 16 to support a recording medium 5, a recording head 20 to eject ink toward the recording medium 5, a scanning mechanism 40 to move the recording head 20 in the primary scanning direction, a feed mechanism 50 to move the recording head 20 and the recording medium 5 relative to each other in the secondary scanning direction, a light irradiator 30, and a controller 60.

The printer 1 is a device for forming an image on the recording medium 5 using an ink that has the property of curing when irradiated with light (i.e., a light-curable ink). Note that an image as used herein includes pictures, patterns, characters, and symbols. The image may be a planar image with small thickness or a three-dimensional image with large thickness. There is no particular limitation on the type of the light-curable ink. In the present example embodiment, the light-curable ink is a UV-curable ink that cures when irradiated with UV light. There is no particular limitation on the shape of the recording medium 5. The recording medium 5 may be a sheet-shaped member such as recording paper, or it may be a three-dimensional object such as a mobile phone case. There is no particular limitation on the material of the recording medium 5 as long as an image can be formed by ink.

In the present example embodiment, the light irradiator 30 preferably includes two UV lamps 32 arranged on the left side and the right side of the recording head 20. Note however that it is possible to omit either the left or right UV lamp 32. The UV lamps 32 are fixed to the recording head 20. The UV lamps 32 are configured to move together with the recording head 20 in the primary scanning direction. The recording head 20 and the UV lamps 32 are attached to a carriage 42.

The scanning mechanism 40 includes a guide rail 43 extending in the primary scanning direction, an endless belt 44 to which the carriage 42 is fixed, a left pulley 45L and a right pulley 45R around which the belt 44 is wound, and a carriage motor 46 for driving the pulley 45L. The carriage 42 is slidably engaged with the guide rail 43. As the carriage motor 46 is driven, the belt 44 runs, and the carriage 42 moves in the primary scanning direction. Therefore, the recording head 20 and the light irradiator 30 move in the primary scanning direction.

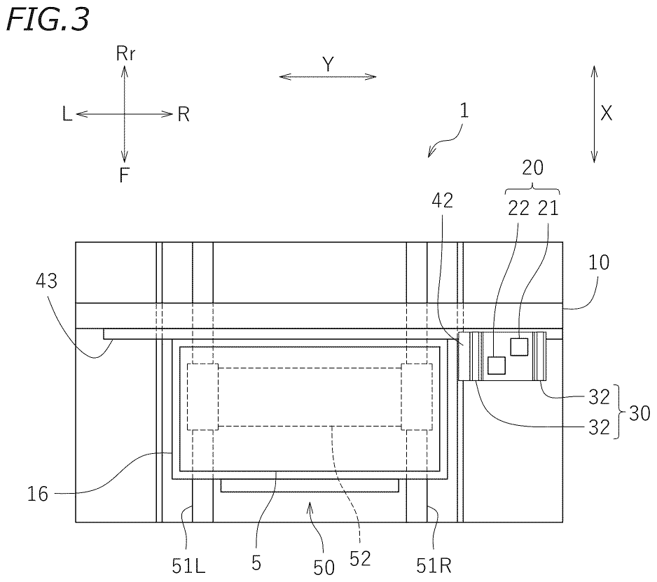

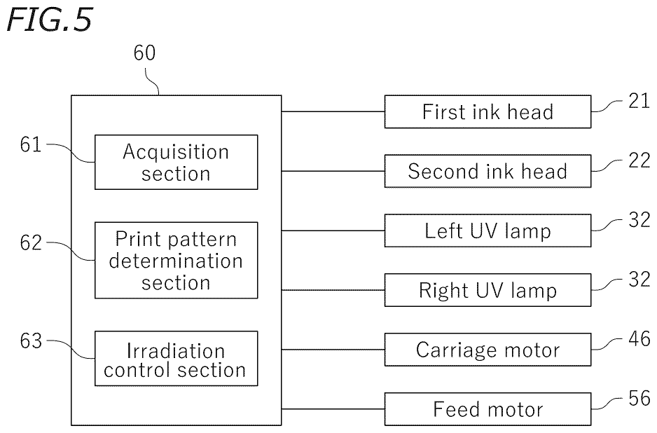

The feed mechanism 50 is configured or programmed to drive the table 16 in the secondary scanning direction to cause the recording medium 5 to move in the secondary scanning direction relative to the recording head 20. As shown in FIG. 3, the feed mechanism 50 includes a left slide rail 51L and a right slide rail 51R extending in the secondary scanning direction, a ball screw (not shown) extending in the secondary scanning direction, a slider 52 that supports the table 16, a feed motor 56 that rotates the ball screw (see FIG. 5). The slider 52 is slidably engaged with the slide rails 51L, 51R. A threaded hole (not shown) that meshes with the ball screw is formed in the slider 52. As the feed motor 56 is driven, the ball screw rotates, and the slider 52 moves in the secondary scanning direction. This causes the table 16 to move in the secondary scanning direction, and the recording medium 5 placed on the table 16 moves in the secondary scanning direction.

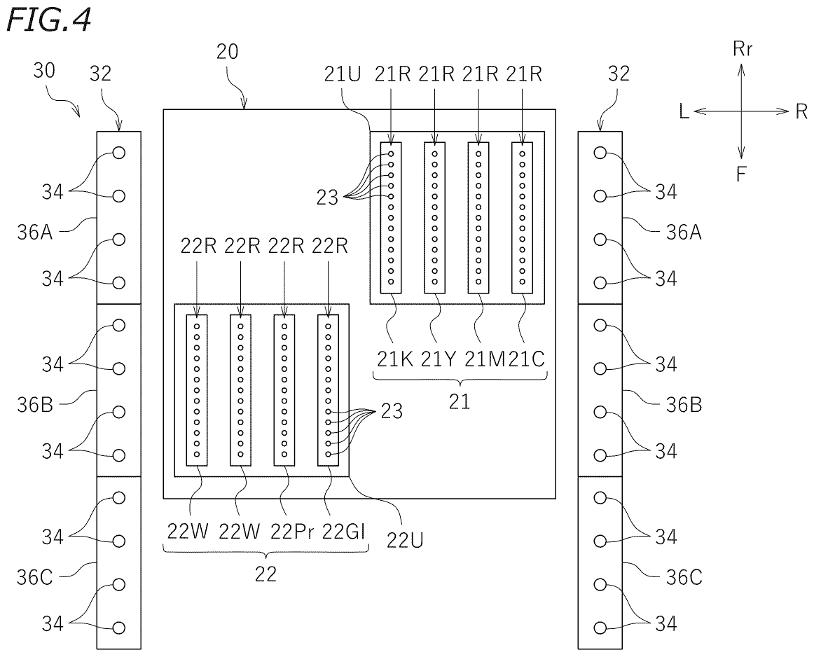

FIG. 4 is a diagram showing the arrangement of the recording head 20 and the light irradiator 30. The recording head 20 includes a first head unit 21U and a second head unit 22U.

The first head unit 21U includes an ink head 21K to eject a black ink, an ink head 21Y to eject a yellow ink, an ink head 21M to eject a magenta ink, and an ink head 21C to eject a cyan ink. Black ink, yellow ink, magenta ink, and cyan ink are examples of process color inks. Black ink, yellow ink, magenta ink, and cyan ink have the property of curing when receiving UV light and are examples of the “first light-curable ink”. The ink heads 21K, 21Y, 21M, 21C are examples of the “first ink heads”. In the following description, the ink heads 21K, 21Y, 21M, 21C will be referred to collectively as a first ink head 21 as needed.

The second head unit 22U includes two ink heads 22W to eject a white ink, an ink head 22Pr to eject a primer ink, and an ink head 22Gl to eject a gloss ink. White ink, primer ink, and gloss ink are examples of specialty inks. A specialty ink may be a metallic ink including metal particles. A specialty ink is an ink that imparts special effects to images formed with a process color ink. A white ink is an ink that forms the base layer of an image, a primer ink is an ink that improves image adhesion, and a gloss ink and a metallic ink are inks that enhance the glossiness of an image. White ink, primer ink, and gloss ink have the property of curing when receiving UV light and are examples of the “second light-curable ink”. The ink heads 22W, 22Pr, 22Gl are examples of the “second ink heads”. In the following description, the ink heads 22W, 22Pr, 22Gl will be referred to collectively as a second ink head 22 as needed.

The first ink head 21 and the second ink head 22 each have a plurality of nozzles 23 arranged in the secondary scanning direction. The nozzles 23 are open toward the downward direction. The nozzles 23 of the first ink head 21 arranged in the secondary scanning direction define a first nozzle row 21R. The nozzles 23 of the second ink head 22 arranged in the secondary scanning direction define a second nozzle row 22R. In the present example embodiment, the second head unit 22U is arranged leftward and forward of the first head unit 21U. The position of the first head unit 21U in the secondary scanning direction and the position of the second head unit 22U in the secondary scanning direction are different from each other. At least some nozzles 23 of the second nozzle row 22R are arranged forward of the first nozzle row 21R. Here, the entire second nozzle row 22R is arranged forward relative to the first nozzle row 21R.

As described above, the light irradiator 30 includes UV lamps 32 arranged leftward and rightward of the recording head 20. The UV lamp 32 includes a plurality of light-emitting elements 34 arranged in the secondary scanning direction. In the present example embodiment, the controller 60 is configured or programmed to divide the UV lamp 32 into three irradiation sections 36A, 36B, 36C to adjust the light amount for each of the irradiation sections 36A, 36B, 36C. The irradiation sections 36A, 36B, 36C are capable of individually adjusting the light amounts thereof. Note that light amount adjustment includes setting the output to 0% (in other words, turning off), to 100%, and to a value greater than 0% and less than 100%.

The irradiation sections 36A, 36B, 36C are arranged in the secondary scanning direction. The irradiation sections 36A, 36B, 36C are arranged in this order from rearward to forward. For the secondary scanning direction, the irradiation section 36A is arranged at the same position as the first nozzle row 21R, and the irradiation section 36B is arranged at the same position as the second nozzle row 22R. The irradiation section 36C is arranged forward relative to the first nozzle row 21R and the second nozzle row 22R. The position of the irradiation section 35C in the secondary scanning direction is different from the positions of the first nozzle row 21R and the second nozzle row 22R in the secondary scanning direction.

The controller 60 is configured or programmed to control the recording head 20, the light irradiator 30, the scanning mechanism 40, and the feed mechanism 50 based on the print data. Although not shown in the figures, the controller 60 may be implemented by a microcomputer, including an interface (I/F) to receive data, etc., from an external device such as a host computer, a central processing unit (CPU) to execute instructions of the control program, a ROM to store programs executed by the CPU, a RAM used as a working area to deploy programs, and a storage device, such as memory, to store the programs and various data. In the present example embodiment, the controller 60 is arranged inside the case 10 and is a dedicated computer for the printer 1. Note however that the controller 60 may be arranged outside the case 10 and may be a general-purpose computer such as a personal computer. As shown in FIG. 5, the CPU of the controller 60 executes a computer program to function as an acquisition section 61 that acquires print data including data regarding the ejection action of the first nozzle row 21R and the second nozzle row 22R, a print pattern determination section 62 that determines a print pattern indicating a combination of the whether or not ink is ejected from the first nozzle row 21R and the whether or not ink is ejected from the second nozzle row 22R based on the print data, and an irradiation control section 63 that adjusts the light amount of each irradiation section 36A, 36B, 36C of the light irradiator 30 based on the print pattern. The ejection action of the first nozzle row 21R refers to the ejection action of the nozzles 23 of the first nozzle row 21R, and the ejection action of the second nozzle row 22R refers to the ejection action of the nozzles 23 of the second nozzle row 22R. The controller 60 is configured or programmed to include the acquisition section 61, the print pattern determination section 62, and the irradiation control section 63. The controller 60 is communicatively connected to the first ink head 21, the second ink head 22, the left and right UV lamps 32, the carriage motor 46, and the feed motor 56.

The printer 1 alternately repeats the path action of ejecting ink from the recording head 20 while moving the carriage 42 in the primary scanning direction, and the feed action of moving the recording medium 5 forward. In the present example embodiment, forward corresponds to the “feed direction”. In the present example embodiment, the printer 1 performs so-called bidirectional printing. The recording head 20 ejects ink when the carriage 42 is moving leftward and when the carriage 42 is moving rightward. Note however that the printer 1 may be configured to perform unidirectional printing. The recording head 20 may eject ink only when the carriage 42 is moving leftward or only when the carriage 42 is moving rightward.

In the present example embodiment, the pass action and the feed action are repeated four times for an area of the recording medium 5 of a size corresponding to the first nozzle row 21R, in other words, an area of the recording medium 5 between the front end and the rear end of the first nozzle row 21R to thus form an image on this area using a process color ink. That is, the number of passes is set to four. Note however that the number of passes is not limited to four. The number of passes may be two or more, but may also be one. Similarly, the pass action and the feed action are repeated four times for an area of the recording medium 5 of a size corresponding to the second nozzle row 22R, in other words, an area of the recording medium 5 between the front end and the rear end of the second nozzle row 22R, thereby forming an image on this area using a specialty ink. The print data includes data regarding the ejection action of the first nozzle row 21R and the second nozzle row 22R for each pass action. Hereinafter, this data will be referred to as pass data. The print data includes a plurality of pass data. The irradiation control section 63 is configured or programmed to adjust the light amount of each irradiation section 36A, 36B, 36C based on the pass data.

The printer 1 is capable of executing a print pattern (hereinafter referred to as the first print pattern) in which ink is ejected from the first nozzle row 21R and ink is not ejected from the second nozzle row 22R, and a print pattern (hereinafter referred to as the second print pattern) in which ink is ejected from the first nozzle row 21R and the second nozzle row 22R, and a print pattern (hereinafter referred to as the third print pattern) in which ink is not ejected from the first nozzle row 21R and ink is ejected from the second nozzle row 22R. Note that ejecting ink from the first nozzle row 21R means ejecting ink from at least one nozzle 23 of the first nozzle row 21R of the ink head 21K, 21Y, 21M, 21C, and not ejecting ink from the first nozzle row 21R means not ejecting ink from any of the nozzles 23 of the first nozzle row 21R of the ink head 21K, 21Y, 21M, 21C. Ejecting ink from the second nozzle row 22R means ejecting ink from at least one nozzle 23 of the second nozzle row 22R of the ink head 22W, 22Pr, 22Gl, and not ejecting ink from the second nozzle row 22R means not ejecting ink from any of the nozzles 23 of the second nozzle row 22R of the ink head 22W, 22Pr, 22Gl. Next, the control of the light irradiator 30 for each print pattern will be described.

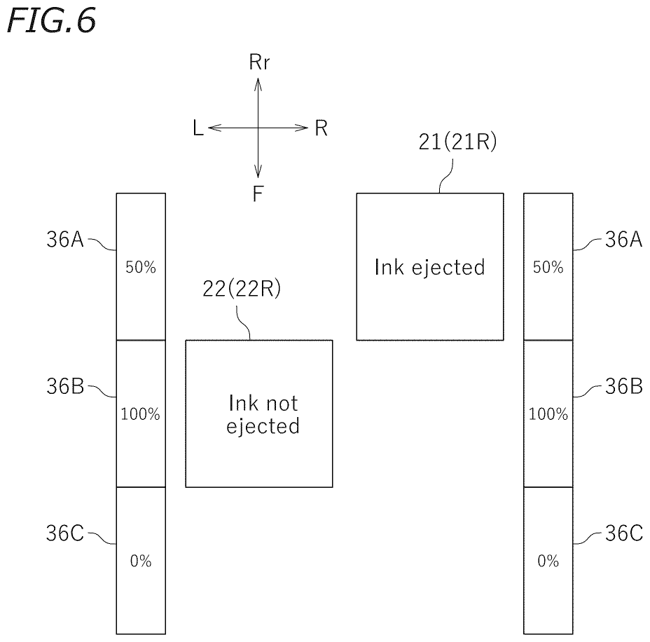

With the first print pattern, the irradiation control section 63 of the controller 60 is configured or programmed to adjust the light amounts of the irradiation sections 36A to 36C of the UV lamp 32 as shown in FIG. 6. That is, the irradiation control section 63 is configured or programmed to turn on the irradiation sections 36A to 36B and turn off the irradiation section 36C. The irradiation control section 63 is configured or programmed to turn off the irradiation section 36C, which is farthest away from the first nozzle row 21R for the secondary scanning direction from among the irradiation sections 36A to 36C. In the first print pattern, since ink is not ejected from the second nozzle row 22R, insufficient ink curing does not occur even with the irradiation section 36C turned off. This avoids excessive irradiation from the UV lamp 32. The irradiation control section 63 is configured or programmed to control the irradiation sections 36A to 36B so that the light amount gradually increases in the forward direction. The light amount of the irradiation section 36B is greater than the light amount of the irradiation section 36A. Here, the irradiation control section 63 sets the outputs of the irradiation sections 36A, 36B, 36C to 50%, 100%, 0%, respectively. Therefore, ink ejected from the first nozzle row 21R does not cure immediately upon striking the recording medium 5, but cures after having spread sufficiently. Therefore, it is possible to obtain images with excellent color reproduction. Note that the total light amount of the irradiation sections 36A to 36B is preferably set so that the cumulative light amount received by the ink coincides with the ink's critical exposure amount (the light amount required for the ink to fully solidify). Thus, ink can be irradiated in an amount that is neither excessive nor insufficient.

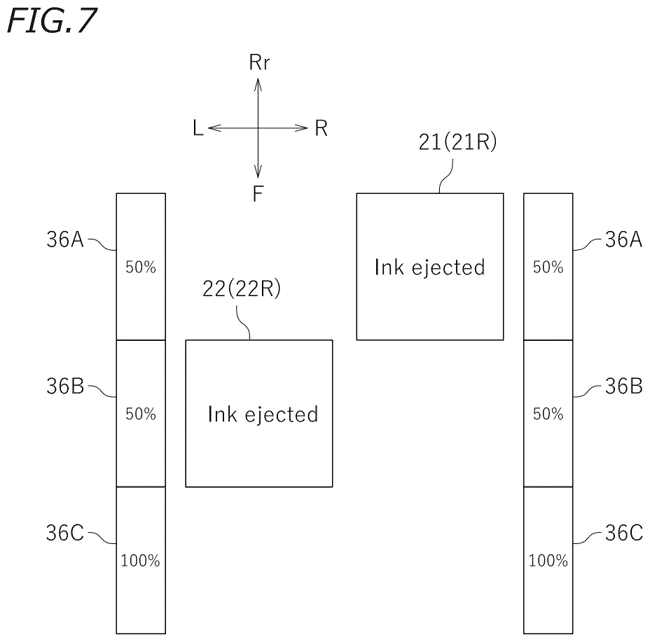

With the second print pattern, the irradiation control section 63 of the controller 60 is configured or programmed to adjust the light amount of the irradiation sections 36A to 36C of the UV lamp 32 as shown in FIG. 7. That is, the irradiation control section 63 is configured or programmed to turn on all of the irradiation sections 36A to 36C. The irradiation control section 63 is configured or programmed to control the irradiation sections 36A to 36C so that the light amount of the foremost irradiation section 36C is greater than the light amount of each of the other irradiation sections 36A to 36B. Here, the irradiation control section 63 is configured or programmed to set the outputs of the irradiation sections 36A, 36B, 36C to 50%, 50%, 100%, respectively. Note that also in the second print pattern, it is preferred that the total light amount of the irradiation sections 36A to 36C is set so that the cumulative light amount received by the ink coincides with the ink's critical exposure amount.

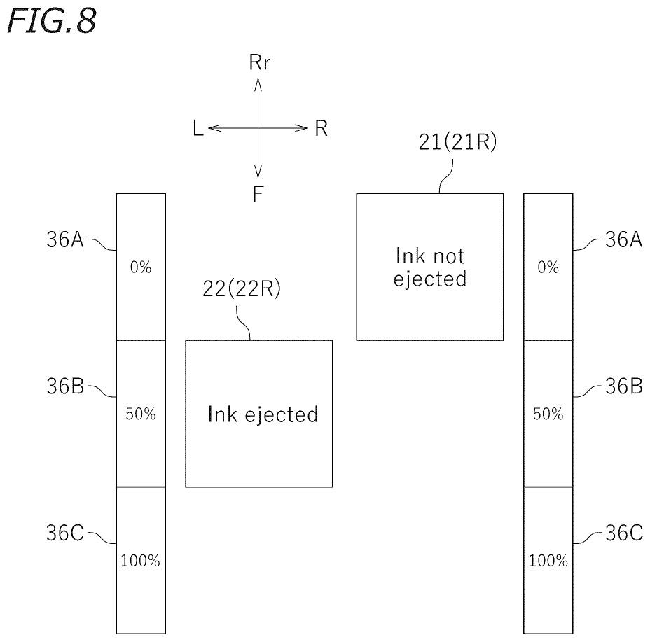

With the third print pattern, the irradiation control section 63 of the controller 60 is configured or programmed to adjust the light amount of the irradiation sections 36A to 36C of the UV lamp 32 as shown in FIG. 8. That is, the irradiation control section 63 is configured or programmed to turn off the irradiation section 36A and turn on the irradiation sections 36B to 36C. The irradiation control section 63 is configured or programmed to turn off the irradiation section 36A, which is on the upstream side of the second nozzle row 22R for the secondary scanning direction from among irradiation sections 36A to 36C. Since ink is not ejected from the first nozzle row 21R with the third print pattern, insufficient ink curing does not occur even with irradiation section 36A turned off. This avoids excessive irradiation from the UV lamp 32. The irradiation control section 63 is configured or programmed to control the irradiation sections 36B to 36C so that the light amount gradually increases in the forward direction. The light amount of the irradiation section 36C is greater than the light amount of the irradiation section 36B. Here, the irradiation control section 63 is configured or programmed to set the outputs of the irradiation sections 36A, 36B, 36C to 0%, 50%, 100%, respectively. Thus, ink ejected from the second nozzle row 22R does not cure immediately upon striking the recording medium 5, but cures after having spread sufficiently. Also with the third print pattern, the total light amount of the irradiation sections 36B to 36C is preferably set so that the cumulative light amount received by the ink coincides with the ink's critical exposure amount.

The print pattern determination section 62 of the controller 60 is configured or programmed to determine which of the first print pattern, the second print pattern, and the third print pattern to execute for each pass action based on the print data acquired by the acquisition section 61. The irradiation control section 63 is configured or programmed to adjust the light amount of the irradiation sections 36A to 36C for each pass action according to the print pattern. The irradiation control section 63 is configured or programmed to adjust the light amount of the irradiation sections 36A to 36C for each path data.

Next, various effects achieved by the printer 1 according to the present example embodiment will be described.

With the printer 1 according to the present example embodiment, the light irradiator 30 includes a plurality of irradiation sections 36A to 36C arranged in the secondary scanning direction, and the light amount of each of these irradiation sections 36A to 36C can be adjusted. The light amount of each of the irradiation sections 36A to 36C is adjusted based on the print pattern. Since it is possible to reduce or prevent excessive light irradiation from the light irradiator 30, it is possible to effectively reduce or prevent reflected light. Therefore, it is possible to reduce or prevent the incidence of reflected light on the recording head 20, and it is possible to sufficiently reduce or prevent issues such as clogging of the nozzles 23 of the recording head 20. Therefore, there is no need to frequently perform cleaning of the recording head 20, and it is possible to avoid consumption of large amounts of ink for cleaning. Since ink on the recording medium 5 can be sufficiently irradiated with light, it is possible to improve the print quality.

In the present example embodiment, the output of at least one of the irradiation sections 36A to 36C is set to a value greater than 0% and less than 100%. According to the present example embodiment, compared to a control that merely switches the irradiation sections 36A to 36C on/off (in other words, a control that merely switches the output of the irradiation sections 36A to 36C to 100% or 0%), it is easier to irradiate the ink on the recording medium 5 with light in an amount that is neither excessive nor insufficient.

The irradiation control section 63 is configured or programmed to adjust the light amount of the irradiation sections 36A to 36C based on the print pattern for each pass action. The print data includes pass data, which is data regarding the ejection action of the first nozzle row 21R and the second nozzle row 22R for each pass action, and the irradiation control section 63 is configured or programmed to adjust the light amount of the irradiation sections 36A to 36C based on the pass data. Therefore, it is possible to prevent the light amount of the irradiation sections 36A to 36C from being excessive or insufficient for each pass action.

The position of the first nozzle row 21R and the position of the second nozzle row 22R in the secondary scanning direction may be partially the same, but are different in the present example embodiment. The second nozzle row 22R is arranged forward relative to the first nozzle row 21R. The nozzles 23 of the second nozzle row 22R are arranged forward relative to the first nozzle row 21R. Therefore, the control described above for adjusting the light amount of the irradiation sections 36A to 36C, which are arranged in the front-rear direction, is more effectively achieved. For example, it is possible to effectively reduce or prevent the incidence of reflected light on the recording head 20 by turning off the irradiation section 36C for the first print pattern and turning off the irradiation section 36A for the third print pattern.

As shown in FIG. 6, the light irradiator 30 includes the irradiation section 36A arranged on one side of the first nozzle row 21R in the primary scanning direction, the irradiation section 36B arranged on one side of the second nozzle row 22R in the primary scanning direction and forward of the irradiation section 36A, and the irradiation section 36C arranged forward of the irradiation section 36B. With the first print pattern, the first nozzle row 21R ejects ink and the second nozzle row 22R does not eject ink. The irradiation control section 63 is configured or programmed to turn on the irradiation section 36A, turn on the irradiation section 36B, and turn off the irradiation section 36C. Thus, the ink ejected from the first nozzle row 21R can be sufficiently cured while eliminating irradiation from the irradiation section 36C to thus prevent excessive irradiation from the light irradiator 30. It is possible to effectively reduce or prevent reflected light toward the recording head 20.

According to the present example embodiment, with the first print pattern, the light amount of the irradiation section 36B is greater than the light amount of the irradiation section 36A. Thus, it is possible to obtain a high-quality image while reducing or preventing reflected light.

As shown in FIG. 7, the light irradiator 30 includes the irradiation section 36A arranged on one side of the first nozzle row 21R in the primary scanning direction, the irradiation section 36B arranged on one side of the second nozzle row 22R in the primary scanning direction and forward of the irradiation section 36A, and the irradiation section 36C arranged forward of the irradiation section 36B. With second print pattern, the first nozzle row 21R ejects ink and the second nozzle row 22R ejects ink. The irradiation control section 63 is configured or programmed to turn on the irradiation section 36A, turn on the irradiation section 36B, and turn on the irradiation section 36C. Thus, the ink ejected from the first nozzle row 21R and the second nozzle row 22R can be sufficiently cured.

According to the present example embodiment, with the second print pattern, the light amount of the irradiation section 36C is greater than the light amount of the irradiation section 36B. Thus, it is possible to obtain a high-quality image while reducing or preventing reflected light.

As shown in FIG. 8, the light irradiator 30 includes the irradiation section 36A arranged on one side of the first nozzle row 21R in the primary scanning direction, the irradiation section 36B arranged on one side of the second nozzle row 22R in the primary scanning direction and forward of the irradiation section 36A, and the irradiation section 36C arranged forward of the irradiation section 36B. With the third print pattern, the first nozzle row 21R does not eject ink, and the second nozzle row 22R ejects ink. The irradiation control section 63 is configured or programmed to turn off the irradiation section 36A, turn on the irradiation section 36B, and turn on the irradiation section 36C. Thus, the ink ejected from the second nozzle row 22R can be sufficiently cured while eliminating irradiation from the irradiation section 36A to thus prevent excessive irradiation from the light irradiator 30. It is possible to effectively reduce or prevent reflected light toward the recording head 20.

According to the present example embodiment, with the third print pattern, the light amount of the irradiation section 36C is greater than the light amount of the irradiation section 36B. Thus, it is possible to obtain a high-quality image while reducing or preventing reflected light.

While example embodiments of the present invention have been described above, the above example embodiments are merely illustrative. Various other example embodiments are possible.

While the number of first ink heads 21 and the number of second ink heads 22 are both four in the example embodiments described above, there is no limitation on these numbers. The recording head 20 may include one or two or more other ink heads in addition to the first ink head 21 and the second ink head 22.

The scanning mechanism is not limited to the scanning mechanism 40 of the example embodiments described above as long as the scanning mechanism is capable of moving the recording head 20 in the primary scanning direction. The feed mechanism is not limited to the feed mechanism 50 of the example embodiments described above as long as the feed mechanism is capable of moving the recording medium 5 in the secondary scanning direction relative to the recording head 20. The feed mechanism may include feed rollers to transfer the recording medium 5 forward. The feed mechanism may be a mechanism to move the recording head 20 in the secondary scanning direction while keeping the recording medium 5 stationary. The printer is not limited to a flatbed printer and may also be a roll-to-roll printer.

The light-curable ink (the first light-curable ink) ejected from the first nozzle row 21R is not limited to a process color. The light-curable ink (the second light-curable ink) ejected from the second nozzle row 22R is not limited to a specialty ink.

While the entire second nozzle row 22R of the second ink head 22 is arranged forward relative to the first nozzle row 21R of the first ink head 21 in the example embodiments described above, only some of the nozzles 23 of the second nozzle row 22R may be arranged forward relative to the first nozzle row 21R. Some of the nozzles 23 of the first nozzle row 21R and some of the nozzles 23 of the second nozzle row 22R may be arranged at the same location for the secondary scanning direction.

While the UV lamp 32 is divided into three irradiation sections 36A to 36C, in the example embodiments described above, the number of irradiation sections is not limited to three. The number of irradiation sections may be two, or four or more.

With the first print pattern, the outputs of the irradiation sections 36A, 36B are not limited to 50%, 100%, respectively. The outputs of the irradiation sections 36A, 36B may be equal to each other. The light amount of the irradiation section 36B may be smaller than the light amount of the irradiation section 36A. With the third print pattern, the outputs of the irradiation sections 36B, 36C are not limited to 50%, 100%, respectively. The outputs of the irradiation sections 36B, 36C may be equal to each other. The light amount of the irradiation section 36C may be smaller than the light amount of the irradiation section 36B. With the second print pattern, the outputs of the irradiation sections 36A, 36B, 36C are not limited to 50%, 50%, 100%, respectively. The outputs of two or three of the irradiation sections 36A, 36B, 36C may be equal to each other. The light amount of the irradiation section 36C may be smaller than the light amount of the irradiation section 36A or 36B.

While the position of the irradiation section 36A in the secondary scanning direction is entirely equal to the position of the first nozzle row 21R in the secondary scanning direction in the example embodiments described above, they may be partially equal. Similarly, the position of the irradiation section 36B in the secondary scanning direction may be entirely equal to the position of the second nozzle row 22R in the secondary scanning direction, or may be partially equal.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An inkjet printer comprising:
a recording head including a first nozzle row including a plurality of nozzles arranged in a secondary scanning direction to eject a first light-curable ink toward a recording medium, a second nozzle row arranged on one side of the first nozzle row in a primary scanning direction perpendicular to the secondary scanning direction, the second nozzle row including a plurality of nozzles arranged in the secondary scanning direction to eject a second light-curable ink toward the recording medium;
a head scanner to move the recording head in the primary scanning direction;
a feeder to move the recording head and the recording medium relative to each other in the secondary scanning direction;
a light irradiator to irradiate light toward ink ejected from the recording head; and
a controller configured or programmed to control the recording head, the head scanner, the feeder, and the light irradiator; wherein
the light irradiator includes a plurality of irradiation sections with positions that are different from each other in the secondary scanning direction, the irradiation sections being capable of individually adjusting light amounts thereof; and
the controller is configured or programmed to include:
an acquirer configured or programmed to acquire print data including data regarding an ejection action of the first nozzle row and the second nozzle row;
a print pattern determinator configured or programmed to determine a print pattern indicating a combination of whether or not ink is ejected from the first nozzle row and whether or not ink is ejected from the second nozzle row based on the print data; and
an irradiation controller configured or programmed to adjust the light amounts of the irradiation sections of the light irradiator based on the print pattern.

2. The inkjet printer according to claim 1, wherein
the controller is configured or programmed to alternately repeat a pass action of ejecting ink while moving the recording head in the primary scanning direction, and a feed action of moving the recording head and the recording medium relative to each other in the secondary scanning direction; and
the irradiation controller is configured or programmed to adjust the light amounts of the irradiation sections based on the print pattern for each pass action.

3. The inkjet printer according to claim 1, wherein
the controller is configured or programmed to alternately repeat a pass action of ejecting ink while moving the recording head in the primary scanning direction, and a feed action of moving the recording head and the recording medium relative to each other in the secondary scanning direction;
the print data includes pass data, which is data regarding an ejection action of the first nozzle row and the second nozzle row for each pass action; and
the print pattern determinator is configured or programmed to determine the print pattern based on the pass data.

4. The inkjet printer according to claim 1, wherein
the first light-curable ink is a process color ink; and
the second light-curable ink is a specialty ink.

5. The inkjet printer according to claim 1, wherein
in the movement of the recording medium and the recording head relative to each other in the secondary scanning direction by the feeder, a feed direction is defined as a direction of movement of the recording medium relative to the recording head; and
at least some of the nozzles of the second nozzle row are arranged on the feed direction side relative to the first nozzle row.

6. The inkjet printer according to claim 5, wherein
the light irradiator includes:
a first irradiation section arranged on one side of the first nozzle row in the primary scanning direction, a position of the first irradiation section in the secondary scanning direction being partially or entirely equal to a position of the first nozzle row in the secondary scanning direction;
a second irradiation section arranged on one side of the second nozzle row in the primary scanning direction and on the feed direction side of the first irradiation section, a position of the second irradiation section in the secondary scanning direction being partially or entirely equal to a position of the second nozzle row in the secondary scanning direction; and
a third irradiation section arranged on the feed direction side of the second irradiation section, a position of the third irradiation section in the secondary scanning direction being different from a position of the second nozzle row in the secondary scanning direction; and
the irradiation control section is configured or programmed to turn on the first irradiation section, turn on the second irradiation section, and turn off the third irradiation section when the first nozzle row is ejecting the first light-curable ink and the second nozzle row is not ejecting the second light-curable ink.

7. The inkjet printer according to claim 6, wherein the irradiation controller is configured or programmed so that a light amount of the second irradiation section is greater than a light amount of the first irradiation section when the first nozzle row is ejecting the first light-curable ink and the second nozzle row is not ejecting the second light-curable ink.

8. The inkjet printer according to claim 5, wherein
the light irradiator includes:
a first irradiation section arranged on one side of the first nozzle row in the primary scanning direction, a position of the first irradiation section in the secondary scanning direction being partially or entirely equal to a position of the first nozzle row in the secondary scanning direction;
a second irradiation section arranged on one side of the second nozzle row in the primary scanning direction and on the feed direction side of the first irradiation section, a position of the second irradiation section in the secondary scanning direction being partially or entirely equal to a position of the second nozzle row in the secondary scanning direction; and
a third irradiation section arranged on the feed direction side of the second irradiation section, a position of the third irradiation section in the secondary scanning direction being different from a position of the second nozzle row in the secondary scanning direction; and
the irradiation controller is configured or programmed to turn off the first irradiation section, turn on the second irradiation section, and turn on the third irradiation section when the first nozzle row is not ejecting the first light-curable ink and the second nozzle row is ejecting the second light-curable ink.

9. The inkjet printer according to claim 8, wherein the irradiation controller is configured or programmed so that a light amount of the third irradiation section is greater than a light amount of the second irradiation section when the first nozzle row is not ejecting the first light-curable ink and the second nozzle row is ejecting the second light-curable ink.

10. The inkjet printer according to claim 6, wherein the irradiation controller is configured or programmed to turn on the first irradiation section, turn on the second irradiation section, and turn on the third irradiation section when the first nozzle row is ejecting the first light-curable ink and the second nozzle row is ejecting the second light-curable ink.

11. The inkjet printer according to claim 10, wherein the irradiation controller is configured or programmed so that a light amount of the third irradiation section is greater than a light amount of the second irradiation section when the first nozzle row is ejecting the first light-curable ink and the second nozzle row is ejecting the second light-curable ink.

12. The inkjet printer according to claim 8, wherein the irradiation controller is configured or programmed to turn on the first irradiation section, turn on the second irradiation section, and turn on the third irradiation section when the first nozzle row is ejecting the first light-curable ink and the second nozzle row is ejecting the second light-curable ink.

13. The inkjet printer according to claim 12, wherein the irradiation controller is configured or programmed so that a light amount of the third irradiation section is greater than a light amount of the second irradiation section when the first nozzle row is ejecting the first light-curable ink and the second nozzle row is ejecting the second light-curable ink.
